(19) United States
(12) Patent Application Publication
(10) Pub. No.: US 2002/0155239 A1
(43) Pub. Date: Oct. 24, 2002

(54) Unmemory cold deformable plastic object prepared by drawing

(75) Inventors: Donald Shiou Tarng Wang, Taichung (TW); Yi-Jung Huang, Taichung (TW); Chih-Chiang Chen, Hsinchu (TW); Tin-Liou Huang, Taichung (TW); Wen-Kai Chang, Taichung (TW); Shun-Sian Huang, Taipei (TW)

Correspondence Address: BACON & THOMAS, 4th Floor, 625 Slaters Lane, Alexandria, VA, 22314, US

(73) Assignee: Kuo Paoch Chemical Co., Ltd., Taichung (TW)

(21) Appl. No.: 09/880,805

(22) Filed: Jun. 15, 2001

(30) Foreign Application Priority Data
Feb. 22, 2001 (TW) 90104288

(51) Int. Cl. B32B 1/08

(52) U.S. Cl. 428/36.9; 428/364

(57) ABSTRACT

A cold deformable and unmemory plastic object is disclosed, which can be prepared from one single plastic material by drawing a semi-crystalline or crystalline thermoplastic intermediate at a temperature lower than its melting point to an extent so that said intermediate loses its elasticity substantially. The unmemory plastic object of the present invention may be in the form of a bendable and twistable wire or tape for tying, a collapsible and foldable hollow tube for packing, or a thin rod for supporting, such as a stem of an artificial flower.

### FIELD OF THE INVENTION

The present invention is related to an unmemory cold deformable plastic object, and in particular to an unmemory cold deformable plastic object which is able to be bent, twisted, pressed and folded into a desired shape.

### BACKGROUND OF THE INVENTION

Plastic polymers were mixed in various ratios to obtain a blend having desired properties. U.S. Pat. No. 4,797,313 assigned to Monsanto Company; and U.S. Pat. Nos. 5,607,748; 5,827,461; and 5,989,683 assigned to BEDFORD IND. INC. disclose alloys of polycarbonate and ABS, and polycarbonate and polybutylene terephthalate (PBT) for use as a wireless polymeric twist tie to replace the conventional twist tie made by a metal wire and a coating in the packing application.

J. M. Schultz, Polymer Materials Science, Prentice-Hall, Englewood Cliffs, N.J., 1974, describes stress-strain relationship for a semi-crystalline polymer under cold drawing. At the initial stage of the cold drawing the stress-strain relationship conforms to the Hook's Law, so that the semi-crystalline polymer can regain its elasticity when the drawing force is released. As the cold drawing being continued, the semi-crystalline polymer can not resume its shape due to elasticity fatigue. The semi-crystalline polymer starts thinning at a region, when the drawing force exceeds its yield point. The thinning region grows bigger to an extreme, resulting in a breakage of the semi-crystalline polymer, as the drawing force continues. As to the change in amorphology, the molecules in the amorphous areas are stretched and become more oriented in the drawing direction in this cold drawing process.

A desired orientation of the molecules or crystals of the polymer will not occur, if the polymer is not subjected to an external force during the crystallization thereof. The external force such as drawing will render the molecules or crystals of the polymer become more oriented during the crystallization thereof. For a highly crystalline polymer, the drawing will not substantially affect its degree of crystallinity. With respect to a polymer which is low or intermediate in crystallinity, the drawing will enhance its degree of crystallinity in comparison with the one which is not subjected to the drawing.

A polymer having randomly arranged molecules can be subjected to a drawing in one direction, creating more oriented molecules in that direction, so that its degree of crystallinity is increased, and thus its mechanical strength can be improved. It has been well known that a synthetic fiber or thermoplastic film can be drawn at an elevated temperature lower than their melting temperature in one direction to significantly enhance their mechanical strength in that direction. However, a uni-oriented synthetic fiber or thermoplastic film are easy to be split along the drawing direction. Apparently, a bi-orientation approach will enhance the mechanical strength of a thermoplastic film in both the longitudinal and lateral direction, for example a bi-oriented polypropylene (PP) film. So far, the drawn plastic products still maintain their elastic property.

### SUMMARY OF THE INVENTION

The present invention discloses a unmemory cold deformable plastic object, which can be prepared from one single plastic material by drawing.

Preferably, the unmemory plastic object of the present invention is a bendable and twistable wire or tape for tying, a collapsible hollow tube for packing, or a thin rod for supporting.

The present invention also discloses a method for making an unmemory cold deformable plastic object comprising drawing a semi-crystalline or crystalline thermoplastic intermediate at a temperature lower than its melting point to an extent so that said intermediate loses its elasticity substantially.

The present invention further discloses a method for tying objects comprising drawing a semi-crystalline or crystalline thermoplastic intermediate at a temperature lower than its melting point to an extent so that said intermediate loses its elasticity substantially and thus forms an unmemory cold deformable wire or tape; packing said objects with said unmemory cold deformable wire or tape having a suitable length; and contacting and twisting two ends of said unmemory cold deformable wire or tape having a suitable length.

Preferably, said intermediate is drawn at room temperature or an elevated temperature to a length which is 1.5 to 50 times, and more preferably 5 to 30 times of its original length.

Preferably, said intermediate is drawn at a speed ranging from 10 to 5000 mm/min, more preferably from 50 mm/min to 1000 mm/min, and most preferably from 100 mm/min to 500 mm/min.

Preferably, said intermediate comprises a homopolymer of an ethylenically unsaturate monomer, for examples polyethylene, polypropylene, and poly(vinyl chloride).

Preferably, said intermediate comprises a copolymer or terpolymer of two or more ethylenically unsaturate monomers.

Preferably, said intermediate comprises a polymer selected from the group consisting of polyamide, polycarbonate, polyethylene terephthalate and polybutylene terephthalate.

Preferably, said intermediate is biodegradable.

### DETAILED DESCRIPTION OF THE INVENTION

The present invention utilizes the conventional extruded thermoplastic thin rod or hollow tube to conduct a drawing process, wherein the thin rod or hollow tube are continuously drawn after passing their yield point until the resulting thinning propagates extensively, so that the crystallinity thereof changes and the elasticity thereof substantially vanishes, and thus an unmemory twistable rod-shaped object, or a collapsible and foldable hollow tube are formed.

In the present invention an external force is applied to a substance to change the energy level, and consequently the properties thereof to achieve a new application purpose. A portion of the heat energy of a plastic material in molten state is turned into crystallization energy when it is abruptly cooled, as a result the energy level of the cooled plastic material is increased. A cold drawing process is then carried out to increase the degree of crystallinity of the cooled plastic material with a mechanical force, causing the loss of its elasticity, so that a twistable, collapsible and foldable unmemory plastic object is formed.

In addition to the twist tie application, the unmemory plastic object of the present invention can be used as a stem of an artificial flower or the like decorating articles with advantages in environmental protection and appearance.

As to the collapsible property of the unmemory plastic object of the present invention, a common application is a hollow tube for receiving a fluid, gel or paste. A typical example is a toothpaste tube. The toothpaste tube can be pressed to give a certain amount of the toothpaste, and the pressed portion of the tube will maintain collapse. Moreover, the collapsed portion of the toothpaste tube can be folded or rolled for ease of next usage. The conventional collapsible tube containing a metal layer such as aluminum is cumbersome in recycling for environmental protection. The collapsible hollow tube of the present invention can replace this conventional collapsible tube.

A food grade linear low density polyethylene (LLDPE) which conforms to No. 1771520 regulations issued by U.S. FDA, such as LL120 sold by USI Far East Corp. of Taiwan, with the additives contained therein conforming to the related FDA regulations is allowed to be used as a packing material for food, for example a food container for cooking. Accordingly, an unmemory plastic object made of LL120 will also be permitted to use as a food packing material.

A biodegradable plastic material is preferably used in the present invention to make a twist tie for tying sprouts, so that an untie work can be avoided at the later stage.

A dyed plastic material can be directly used to make the unmemory plastic object having a desired color by drawing in the present invention, which is not only relatively easy to be fabricated, but recycled in comparison with the conventional twist tie having a metal wire inside a plastic coating or paper envelop.

Th extruded plastic intermediate to be drawn into an unmemory plastic object according to the present invention is composed of mainly the thermoplastic polymer. The drawn unmemory plastic object can be recycled after usage, including cutting the recovered unmemory plastic object and heat extruding the resulting small pieces to form a plastic product or intermediate. The plastic product or intermediate so obtained can regain their elasticity. If the plastic product or intermediate are drawn according to the method of the present invention again, an unmemory plastic object which is twistable, collapsible or foldable can be regenerated. Without further elaboration, it is believed that the above description has adequately enabled the present invention. The following specific examples are, therefore, to be construed as merely illustrative, and not limitative of the remainder of the disclosure in any way whatsoever.

### MANUFACTURE OF MEMORY PLASTIC RODS

### PREPARATION EXAMPLE 1

Thermoplastic pellets were heated at a temperature higher than their melting points (Tm), and the resulting molten substances were extruded via a die, so that plastic rod intermediates were formed after cooling.

### PREPARATION EXAMPLE 2

Thermoplastic pellets were heated at a temperature higher than their melting points, the resulting molten substances were extruded via a die having an annual aperture, so that plastic hollow tube intermediates were formed after they were drawn through a cooling bath.

### MANUFACTURE OF UNMEMORY PLASTIC OBJECTS

### EXAMPLE 1

The elastic plastic rod intermediates prepared in Preparation Example 1 were drawn at room temperature with a tensile testing machine and with a speed of 200 mm/min after a length of 2 cm being marked thereon. The length was extended to various times, and the appearance of the extended rod became more opaque compared to that of the intermediate. The elasticity, twistability, and foldability of the extended rods were examined and a portion of the results are listed in Table 1.

TABLE 1

| | Density | M.I.^{b)} | Times of | | | |
|---|---|---|---|---|---|---|
| Plastics^{a)} | (g/cm³) | (g/10 min) | extension | Elasticity | Twistability | Foldability |
| 8003 | 0.958 | 0.25 | 7.5 | Disappears | Yes | Yes |
| 8010 | 0.956 | 1.0 | 8 | Disappears | Yes | Yes |
| LH-901 | 0.956 | 0.95 | 8 | Disappears | Yes | Yes |
| NAT | — | 33.7 | 3.5 | Disappears | Yes | Yes |
| NAT | — | 33.7 | 4 | Disappears | Yes | Yes |
| 2100 | 1.43 | — | 4 | Disappears | Yes | Yes |
| Sunylon 6N | 1.13 | 10 | 3 | Disappears | Yes | Yes |
| ST-611 | 0.898 | 1.8 | 7.5 | Disappears | Yes | Yes |
| PET | | 1.05^{c)} | 6 | Disappears | Yes | Yes |
| ^{a)}8003 is high density polyethylene (HDPE) manufactured by Formosa Plastics Corp., Taiwan; 8010 is high density polyethylene (HDPE) manufactured by Formosa Plastics Corp., Taiwan; LH-901 is high density polyethylene (HDPE) manufactured by USI Far East Corp., Taiwan; NAT is polybutylene terephthalate (PBT) manufactured by BASF Co., Germany; 2100 is PBT manufactured by Chang Chun Plastics Co., Ltd.; Sunylon 6N is NYLON manufactured by | | | | | | |
| # Formosa Chemicals & Fibre Corp.; ST-611 is polypropylene (PP) manufactured by Taiwan Polypropylene Co., Ltd.; PET is a regenerated polyethylene terephthalate prepared by blending a used polyethylene terephthalate with an epoxy resin as a chain extender by Chemical Engineering Laboratories, Industrial Technology Research Institute, Taiwan | | | | | | |

^{b)}Melt flow index;
^{c)}Intrinsic viscosity

### EXAMPLE 2

The elastic plastic hollow tube intermediate prepared in Preparation Example 2 using HDPE (Table 1, code 8003) were drawn at room temperature with a tensile testing machine and with a speed of 200 mm/min after a length of 2 cm being marked thereon. The length was extended eight times to 16 cm, and the appearance of the extended hollow tube became more opaque compared to that of the intermediate. The extended hollow tube lost its elasticity, and became twistable, collapsible and foldable as desired.

### EXAMPLE 3

The elastic plastic rod intermediates prepared in Preparation Example 1 were pre-treated with different temperatures in an oven after a length of 2 cm being marked thereon, and drawn with a tensile testing machine immediately following the removal thereof from the oven. The length was extended 4-15 times to 8-30 cm, and the appearance of the extended rod became more opaque compared to that of the intermediate. The extended rods lost their elasticity, and became twistable and foldable as desired. The extended rods were twisted, and then placed at different testing temperatures to see whether the twisted ties thereof disappeared. The results are shown in Table 2.

TABLE 2

| | Pre-treatment | Testing | |
|---|---|---|---|
| Plastics^{a)} | temperature | temperature^{b)} | Twisted tie |
| 8010 | —^{c)} | 100° C. | Unchanged |
| 8010 | —^{c)} | −10° C. | Unchanged |
| 8010 | 100° C. | 100° C. | Disappears |
| 8010 | 0° C. | 100° C. | Unchanged |
| PET | —^{c)} | 100° C. | Unchanged |
| NAT | —^{c)} | 100° C. | Unchanged |
| ST-611 | —^{c)} | 100° C. | Unchanged |

^{a)}Same as Table 1;
^{b)}Immersed in a boil water bath for 10 minutes, or kept in a refrigerator set at −10° C. for 24 hours
^{c)}No pre-treatment

### EXAMPLE 4

10 cm unmemory plastic rod prepared in Example 1 from HDPE (Table 1, code 8010) was immersed in a boil water bath for 10 minutes, and its length changed to 9.2 cm (8% shrinkage). The length of the 10 cm unmemory plastic rod became 9.15 cm (8.5% shrinkage) for additional 10 minutes heating. In both cases, the shrinking unmemory plastic rod remained twistable and foldable.

In another preferable embodiments of the present invention the unmemory plastic objects prepared according to the method of the present invention were collected, cut into small pieces, melted and molded to recycled plastic products. It was found that the recycled plastic products regained their elasticity, and the recycled plastic products were able to be drawn to an extent so that their elasticity disappeared and became unmemory plastic objects again.

Although the present invention has been described with reference to specific details of certain embodiments thereof, it is not intended that such details should be regarded as limitations upon the scope of the invention except as and to the extent that they are included in the accompanying claims. Many modifications and variations are possible in light of the above disclosure.

1. An unmemory cold deformable plastic object prepared by drawing.

2. The object according to claim 1 being a bendable and twistable wire or tape for tying, a collapsible hollow tube for packing, or a thin rod for supporting.

3. The object according to claim 1 prepared by drawing a semi-crystalline or crystalline thermoplastic intermediate at a temperature lower than its melting point to an extent so that said intermediate loses its elasticity substantially.

4. The object according to claim 3, wherein said intermediate is drawn at room temperature or an elevated temperature to a length which is 1.5 to 50 times of its original length.

5. The object according to claim 4, wherein said intermediate is drawn to a length which is 5 to 30 times of its original length.

6. The object according to claim 3, wherein said intermediate is drawn at a speed ranging from 10 mm/min to 5000 mm/min.

7. The object according to claim 6, wherein said intermediate is drawn at a speed ranging from 50 mm/min to 1000 mm/min.

8. The object according to claim 7, wherein said intermediate is drawn at a speed ranging from 10 mm/min to 500 mm/min.

9. The object according to claim 3, wherein said intermediate comprises a homopolymer of an ethylenically unsaturate monomer.

10. The object according to claim 9, wherein said homopolymer is polyethylene, polypropylene or poly(vinyl chloride).

11. The object according to claim 3, wherein said intermediate comprises a copolymer or a terpolymer of two or more ethylenically unsaturate monomers.

12. The object according to claim 3, wherein said intermediate comprises a polymer selected from the group consisting of polyamide, polycarbonate, polyethylene terephthalate and polybutylene terephthalate.

13. The object according to claim 3, wherein said intermediate is biodegradable.

14. A method for making an unmemory cold deformable plastic object comprising drawing a semi-crystalline or crystalline thermoplastic intermediate at a temperature lower than its melting point to an extent so that said intermediate loses its elasticity substantially.

15. The method according to claim 14, wherein said intermediate is drawn at room temperature or an elevated temperature to a length which is 1.5 to 50 times of its original length.

16. The method according to claim 15, wherein said intermediate is drawn to a length which is 5 to 30 times of its original length.

17. The method according to claim 14, wherein said intermediate is drawn at a speed ranging from 10 mm/min to 5000 mm/min.

18. The method according to claim 17, wherein said intermediate is drawn at a speed ranging from 50 mm/min to 1000 mm/min.

19. The method according to claim 18, wherein said intermediate is drawn at a speed ranging from 100 mm/min to 500 mm/min.

20. The method according to claim 14, wherein said intermediate comprises a homopolymer of an ethylenically unsaturate monomer.

21. The method according to claim 20, wherein said homopolymer is polyethylene, polypropylene, or poly(vinyl chloride).

22. The method according to claim 14, wherein said intermediate comprises a copolymer or terpolymer of two or more ethylenically unsaturate monomers.

23. The method according to claim 14, wherein said intermediate comprises a polymer selected from the group consisting of polyamide, polycarbonate, polyethylene terephthalate and polybutylene terephthalate.

24. The method according to claim 14, wherein said intermediate is biodegradable.

25. A method for tying objects comprising packing said objects with an unmemory cold deformable wire or tape having a suitable length prepared according to the method defined in any one of claims 14 to 24; and contacting and twisting two ends of said unmemory cold deformable wire or tape having a suitable length.
